(19) United States
(12) Patent Application Publication
(10) Pub. No.: US 2018/0239839 A1
(43) Pub. Date: Aug. 23, 2018

(54) Method and Apparatus for Identifying To-Be-Cleaned Data, and Electronic Device

(71) Applicant: Beijing Kingsoft Internet Security Software Co., Ltd., Beijing (CN)

(72) Inventors: Qingqing Yu, Beijing (CN); Xin Ruan, Beijing (CN)

(21) Appl. No.: 15/752,162

(22) PCT Filed: Aug. 24, 2016
(86) PCT No.: PCT/CN2016/096557

§ 371 Date: Feb. 12, 2018

(30) Foreign Application Priority Data
Aug. 27, 2015 (CN) 201510536577.9

(51) Int. Cl. G06F 17/30

(52) U.S. Cl. CPC G06F 17/30997; G06F 17/30106; G06F 17/30138; G06F 17/30117

(57) ABSTRACT

Embodiments of the present application disclose a method, apparatus and electronic device for identifying to-be-cleaned data. The method comprises: scanning files and folders located in storage space; obtaining data size and first-type feature information of the scanned files and second-type feature information of the scanned folders; determining folders, among the folders, whose second-type feature information conforms to preset folder feature information as operational folders; determining folders, among the operational folders, which do not satisfy a preset conventional junk judging condition as intermediate folders; determining whether each of the intermediate folders is a to-be-cleaned folder based on data sizes of files contained in this intermediate folder; determining files, other than files in the operational folders, whose data size exceeds a first predetermined data size threshold and whose first-type feature information does not conform to preset file feature information as to-be-cleaned files; determining the to-be-cleaned files and the to-be-cleaned folders as to-be-cleaned data. Large files and large folders to be cleaned in storage space can be identified effectively by applying this solution.

The present application claims the priority of a Chinese patent application No. 201510536577.9, filed with the State Intellectual Property Office of People's Republic of China on Aug. 27, 2015 and entitled “METHOD AND APPARATUS FOR IDENTIFYING TO-BE-CLEANED DATA, AND ELECTRONIC DEVICE”, which is incorporated herein by reference in its entirety.

### TECHNICAL FIELD

The present application relates to the field of data processing, and more particularly to a method, apparatus and electronic device for identifying to-be-cleaned data.

### BACKGROUND

With rapid developments of science and technology, various electronic devices constantly enrich and facilitate people's lives. Electronic devices become an indispensable part of people's lives or work, since processing information with electronic devices has advantages of being convenient, quick, resource saving and the like.

Data (files or folders) will be cached or generated during the running of an application program/system in an electronic device, and the data will be automatically stored in corresponding storage space. However, the capacity of the storage space of an electronic device is limited, so it is necessary to clean up the storage space in order to release the storage space to ensure a subsequent normal operation of the system or application program. In order to clean up storage space, junk cleaning software in the prior art usually determines conventional junk data (conventional junk files and folders) based on previous statistical analysis and then directly deletes the determined conventional junk data, so as to achieve a cleaning effect.

However, the present applicant found that large files (data size of a file is greater than a predetermined value, e.g., 50M) and large folders (data size of a folder is greater than a predetermined value, e.g., 100M) other than conventional junk data, once useless for users, will waste a great amount of storage space because of a large data size. Thus, these large files and folders can be considered as to-be-cleaned data and it is up to users whether to delete them after identifying. For example: a large file can be a film cached by a user through video play software, if it have been watched by the user, this film is very likely to be useless for this user and thus can be deemed as to-be-cleaned data; a large folder can be a folder, under a parent folder of an application program, for storing various photos of a user, if the photos in this folder have been saved by the user, this folder is very likely to be useless for the user and thus can be deemed as to-be-cleaned data.

Based on the above requirements, embodiments of the present application provide a to-be-cleaned data identification scheme for large files and large folders, so as to effectively identify large files and large folders to be cleaned in storage space.

### CONTENTS OF THE INVENTION

In view of the above problems, embodiments of the present application disclose a method, apparatus and electronic device for identifying to-be-cleaned data, so as to identify large files and large folders to be cleaned in storage space. The technical solutions are as follows.

In a first aspect, embodiments of the present application provide a method for identifying to-be-cleaned data, which is applicable to an electronic device. The method comprises:

scanning files and folders located in storage space of the electronic device;

obtaining data size and first-type feature information of the scanned files and second-type feature information of the scanned folders;

determining folders, among the scanned folders, whose second-type feature information conforms to preset folder feature information as operational folders;

determining folders, among the determined operational folders, which do not satisfy a preset conventional junk judging condition as intermediate folders;

determining whether each of the intermediate folders is a to-be-cleaned folder based on data sizes of files contained in this intermediate folder;

determining files, other than files in the operational folders, whose data size exceeds a first predetermined data size threshold and whose first-type feature information does not conform to preset file feature information as to-be-cleaned files;

determining the determined to-be-cleaned files and the determined to-be-cleaned folders as to-be-cleaned data.

Optionally, the preset folder feature information comprises:

feature information of a parent folder of an application program in an operating system, or feature information of a specific folder of the operating system itself.

Optionally, the preset conventional junk judging condition comprises:

the second-type feature information of a folder conforms to feature information of a preset conventional junk folder;

or,

the first-type feature information of a file in a folder conforms to feature information of a preset conventional junk file;

or,

the second-type feature information of a folder conforms to feature information of a preset conventional junk folder and the first-type feature information of a file in the folder conforms to feature information of a preset conventional junk file.

Optionally, the first-type feature information comprises at least one of a file type, a file path, and a file name;

the second-type feature information comprises at least one of a folder name, a folder path, a file type of a file in a folder.

Optionally, determining whether each of the intermediate folders is a to-be-cleaned folder based on data sizes of files contained in this intermediate folder comprises:

judging whether files in each of the intermediate folders contain a file whose data size exceeds a second predetermined data size threshold;

determining an intermediate folder containing a file whose data size exceeds the second predetermined data size threshold as a to-be-cleaned folder;

determining an intermediate folder not containing a file whose data size exceeds the second predetermined data size threshold as a not-to-be-cleaned folder.

Optionally, determining whether each of the intermediate folders is a to-be-cleaned folder based on data sizes of files contained in this intermediate folder comprises:

judging whether total data size of files in each of the intermediate folder exceeds a third predetermined data size threshold respectively;

determining an intermediate folder whose total data size of contained files exceeds the third predetermined data size threshold as a to-be-cleaned folder;

determining an intermediate whose total data size of contained files does not exceed the third predetermined data size threshold as a non-to-be-cleaned folder.

Optionally, determining whether each of the intermediate folders is a to-be-cleaned folder based on data sizes of files contained in this intermediate folder comprises:

judging whether files in each of the intermediate folders contain a file whose data size exceeds a second predetermined data size threshold;

determining an intermediate folder containing a file whose data size exceeds the second predetermined data size threshold as a to-be-cleaned folder;

continuing to judge whether total data size of files in each of the intermediate folders which do not contain a file whose data size exceeds the second predetermined data size threshold, exceeds a third predetermined data size threshold respectively;

determining an intermediate folder whose total data size of contained files exceeds the third predetermined data size threshold as a to-be-cleaned folder;

determining an intermediate folder whose total data size of contained files does not exceed the third predetermined data size threshold as a non-to-be-cleaned folder.

Optionally, the method for identifying to-be-cleaned data provided by embodiments of the present application further comprises:

displaying the determined to-be-cleaned data, wherein the to-be-cleaned folders are displayed in the form of folder icons and the to-be-cleaned files are displayed in the form of file icons.

In a second aspect, an embodiment of the present application provides an apparatus for identifying to-be-cleaned data, which is applicable to an electronic device. The apparatus comprises:

a scanning module, used for scanning files and folders located in storage space of the electronic device;

a feature information obtaining module, used for obtaining data size and first-type feature information of the scanned files and second-type feature information of the scanned folders;

an operational folder determining module, used for determining folders, among the scanned folders, whose second-type feature information conforms to preset folder feature information as operational folders;

an intermediate folder determining module, used for determining folders, among the determined operational folders, which do not satisfy a preset conventional junk judging condition as intermediate folders;

an intermediate folder processing module, used for determining whether each of the intermediate folders is a to-be-cleaned folder based on data sizes of files contained in this intermediate folder;

a to-be-cleaned file determining module, used for determining files, other than files in the operational folders, whose data size exceeds a first predetermined data size threshold and whose first-type feature information does not conform to preset file feature information as to-be-cleaned files;

a to-be-cleaned data determining module, used for determining the determined to-be-cleaned files and the determined to-be-cleaned folders as to-be-cleaned data.

Optionally, the preset folder feature information comprises:

feature information of a parent folder of an application program in an operating system, or feature information of a specific folder of the operating system itself.

Optionally, the preset conventional junk judging condition comprises:

the second-type feature information of a folder conforms to feature information of a preset conventional junk folder;

or,

the first-type feature information of a file in a folder conforms to feature information of a preset conventional junk file;

or,

the second-type feature information of a folder conforms to feature information of a preset conventional junk folder and the first-type feature information of a file in the folder conforms to feature information of a preset conventional junk file.

Optionally, the first-type feature information comprises at least one of a file type, a file path, and a file name;

the second-type feature information comprises at least one of a folder name, a folder path, a file type of a file in a folder.

Optionally, the intermediate folder processing module comprises:

a first judging unit, used for judging whether files in each of the intermediate folders contain a file whose data size exceeds a second predetermined data size threshold;

a first processing unit, used for determining an intermediate folder containing a file whose data size exceeds the second predetermined data size threshold as a to-be-cleaned folder;

a second processing unit, used for determining an intermediate folder not containing a file whose data size exceeds the second predetermined data size threshold as a non-to-be-cleaned folder.

Optionally, the intermediate folder processing module comprises:

a second judging unit, used for judging whether total data size of files in each of the intermediate folder exceeds a third predetermined data size threshold respectively;

a third processing unit, used for determining an intermediate folder whose total data size of contained files exceeds the third predetermined data size threshold as a to-be-cleaned folder;

a fourth processing unit, used for determining an intermediate folder whose total data size of contained files does not exceed the third predetermined data size threshold as a non-to-be-cleaned folder.

Optionally, the intermediate folder processing module comprises:

a third judging unit, used for judging whether files in each of the intermediate folders contain a file whose data size exceeds a second predetermined data size threshold;

a fifth processing unit, used for determining an intermediate folder containing a file whose data size exceeds the second predetermined data size threshold as a to-be-cleaned folder;

a fourth judging unit, used for continuing to judge whether total data size of files in each of the intermediate folders which do not contain a file whose data size exceeds the second predetermined data size threshold, exceeds a third predetermined data size threshold respectively;

a sixth processing unit, used for determining an intermediate folder whose total data size of contained files exceeds the third predetermined data size threshold as a to-be-cleaned folder;

a seventh processing unit, used for determining an intermediate folder whose total data size of contained files does not exceed the third predetermined data size threshold as a non-to-be-cleaned folder.

Optionally, the apparatus for identifying to-be-cleaned data provided by the embodiment of the present application further comprises:

a displaying module, used for displaying the determined to-be-cleaned data, wherein the to-be-cleaned folders are displayed in the form of folder icons and the to-be-cleaned files are displayed in the form of file icons.

In a third aspect, an embodiment of the present application further provides an electronic device, which comprises a housing, a processor, a memory, a circuit board and a power supply circuit, wherein the circuit board is placed inside a space enclosed by the housing, the processor and the memory are arranged on the circuit board; the power supply circuit is used to supply power for various circuits or elements of the electronic device; the memory is used to store executable program code; and the processor runs a program corresponding to the executable program code by reading the executable program code stored in the memory, so as to perform the following steps:

scanning files and folders located in storage space of the electronic device;

obtaining data size and first-type feature information of the scanned files and second-type feature information of the scanned folders;

determining folders, among the scanned folders, whose second-type feature information conforms to preset folder feature information as operational folders;

determining folders, among the determined operational folders, which do not satisfy a preset conventional junk judging condition as intermediate folders;

determining whether each of the intermediate folders is a to-be-cleaned folder based on data sizes of files contained in this intermediate folder;

determining files, other than files in the operational folders, whose data size exceeds a first predetermined data size threshold and whose first-type feature information does not conform to preset file feature information as to-be-cleaned files;

determining the determined to-be-cleaned files and the determined to-be-cleaned folders as to-be-cleaned data.

In a fourth aspect, an embodiment of the present application provides an application program used for performing the method for identifying to-be-cleaned data provided by embodiments of the present application. The method for identifying to-be-cleaned data comprises:

scanning files and folders located in storage space of the electronic device;

obtaining data size and first-type feature information of the scanned files and second-type feature information of the scanned folders;

determining folders, among the scanned folders, whose second-type feature information conforms to preset folder feature information as operational folders;

determining folders, among the determined operational folders, which do not satisfy a preset conventional junk judging condition as intermediate folders;

determining whether each of the intermediate folders is a to-be-cleaned folder based on data sizes of files contained in this intermediate folder;

determining files, other than files in the operational folders, whose data size exceeds a first predetermined data size threshold and whose first-type feature information does not conform to preset file feature information as to-be-cleaned files;

determining the determined to-be-cleaned files and the determined to-be-cleaned folders as to-be-cleaned data.

In a fifth aspect, an embodiment of the present application provides a storage medium used for storing executable program code which are executed to perform the method for identifying to-be-cleaned data provided by embodiments of the present application. The method for identifying to-be-cleaned data comprises:

scanning files and folders located in storage space of the electronic device;

obtaining data size and first-type feature information of the scanned files and second-type feature information of the scanned folders;

determining folders, among the scanned folders, whose second-type feature information conforms to preset folder feature information as operational folders;

determining folders, among the determined operational folders, which do not satisfy a preset conventional junk judging condition as intermediate folders;

determining whether each of the intermediate folders is a to-be-cleaned folder based on data sizes of files contained in this intermediate folder;

determining files, other than files in the operational folders, whose data size exceeds a first predetermined data size threshold and whose first-type feature information does not conform to preset file feature information as to-be-cleaned files;

determining the determined to-be-cleaned files and the determined to-be-cleaned folders as to-be-cleaned data.

In embodiments of the present application, the following steps are performed: scanning files and folders located in storage space of an electronic device; obtaining data size and first-type feature information of the scanned files and second-type feature information of the scanned folders; determining folders, among the scanned folders, whose second-type feature information conforms to preset folder feature information as operational folders; determining folders, among the determined operational folders, which do not satisfy a preset conventional junk judging condition as intermediate folders; determining whether each of the intermediate folders is a to-be-cleaned folder based on data sizes of files contained in this intermediate folder; determining files, other than files in the operational folders, whose data size exceeds a first predetermined data size threshold and whose first-type feature information does not conform to preset file feature information as to-be-cleaned files; determining the determined to-be-cleaned files and the determined to-be-cleaned folders as to-be-cleaned data. As can be seen, large files and large folders to be cleaned in storage space can be identified effectively by applying this solution.

### BRIEF DESCRIPTION OF THE DRAWINGS

In order to describe the embodiments of the present application and the technical solutions in the prior art more clearly, drawings required to be used in embodiments of the present application and the prior art will be described briefly below. It is obvious that the drawings below are only some embodiments of the present application, and those skilled in the art can also obtain other drawings based on these drawings without any creative efforts.

FIG. 1 is a flowchart of a method for identifying to-be-cleaned data provided by embodiments of the present application;

FIG. 2 is another flowchart of a method for identifying to-be-cleaned data provided by embodiments of the present application;

FIG. 3 is another flowchart of a method for identifying to-be-cleaned data provided by embodiments of the present application;

FIG. 4 is another flowchart of a method for identifying to-be-cleaned data provided by embodiments of the present application;

FIG. 5 is a schematic structural diagram of an apparatus for identifying to-be-cleaned data provided by an embodiment of the present application;

FIG. 6 is a schematic diagram of the specific structure of an intermediate folder processing module comprised in an apparatus for identifying to-be-cleaned data provided by an embodiment of the present application;

FIG. 7 is another schematic diagram of the specific structure of an intermediate folder processing module comprised in an apparatus for identifying to-be-cleaned data provided by an embodiment of the present application;

FIG. 8 is another schematic diagram of the specific structure of an intermediate folder processing module comprised in an apparatus for identifying to-be-cleaned data provided by an embodiment of the present application;

FIG. 9 is a schematic structural diagram of an electronic device provided by an embodiment of the present application.

### SPECIFIC MODE FOR CARRYING OUT THE INVENTION

The technical solutions in the embodiments of the present application will be described clearly and completely below in combination with the accompanying drawings in the embodiments of the present application. Obviously, the described embodiments are only some of the embodiments of the present application, rather than all of the embodiments. All other embodiments obtained based on the embodiments of the present application by those skilled in the art without any creative efforts fall into the protection scope of the present application.

In order to effectively identify large files and large folders to be cleaned in storage space, embodiments of the present application provide a method, apparatus and electronic device for identifying to-be-cleaned data.

First, the method for identifying to-be-cleaned data provided by an embodiment of the present application will be introduced below.

It should be noted that, the method for identifying to-be-cleaned data provided by the present embodiment is applicable to an electronic device. In practical applications, the electronic device can be a smart phone, a tablet PC or a laptop and the like.

It should be emphasized that functional software implementing the method for identifying to-be-cleaned data provided by the present embodiment can be specialized client software, and can also be a plug-in of existing cleaning software for cleaning conventional junk data.

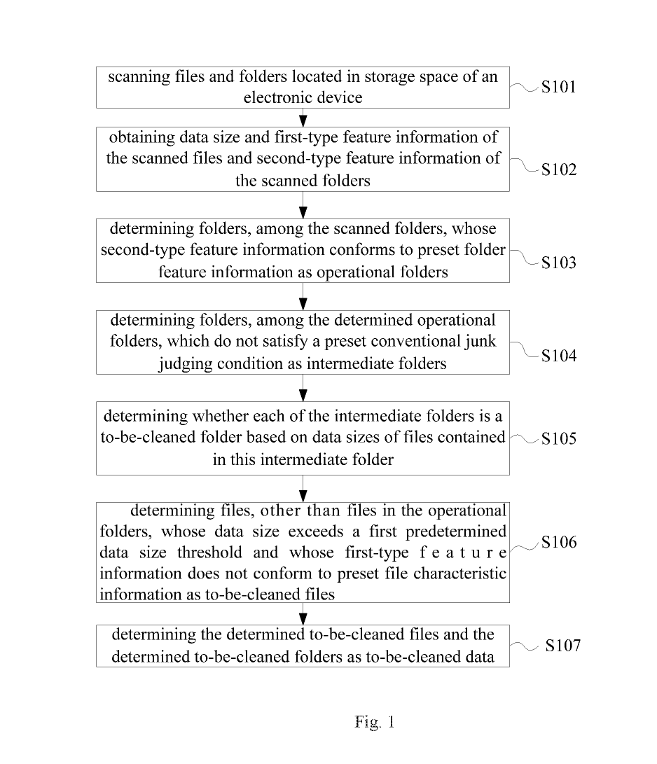

As shown in FIG. 1, the method for identifying to-be-cleaned data can comprise:

S101, scanning files and folders located in storage space of an electronic device;

S102, obtaining data size and first-type feature information of the scanned files and second-type feature information of the scanned folders.

In the process of identifying to-be-cleaned data, first files and folders located in storage space of an electronic device are scanned, and then data size and first-type feature information of the scanned files and second-type feature information of the scanned folders are obtained.

The storage space can be storage space built in an electronic device, and can also be peripheral storage space additionally added by users, such as a SD card (Secure Digital Memory Card), wherein the SD card is a memory card based on semiconductor flash memory technology.

The first-type feature information can comprise at least one of a file type, a file path, and a file name, and of course is not limited thereof.

The second-type feature information can comprise at least one of a folder name, a folder path, a file type of a file in a folder, and of course is not limited thereof.

S103, determining folders, among the scanned folders, whose second-type feature information conforms to preset folder feature information as operational folders.

Since large folders to be cleaned are generally folders associated with an application program and folders associated with an operating system, it is possible to set preset folder feature information based on folders associated with an application program and folders associated with an operating system. After obtaining the second-type feature information of the scanned folders, it is possible to determine folders, among the scanned folders, whose second-type feature information conforms to preset folder feature information as operational folders. Specifically, the preset folder feature information can comprise: feature information of a parent folder of an application program in an operating system, or feature information of a specific folder of the operating system itself.

It should be emphasized that it is possible to statistically analyze feature information of parent folders of various commonly used application programs in an operating system and feature information of specific folders of the operating system itself in advance. The feature information statistically analyzed can be at least one of a folder name, a folder path, a file type of a file in a folder. Besides, it can be understood that the second feature information is determined based on feature information statistically analyzed in advance since match and comparison are needed.

S104, determining folders, among the determined operational folders, which do not satisfy a preset conventional junk judging condition as intermediate folders.

After excluding folders (i.e., conventional junk folders) that satisfy a preset conventional junk judging condition from the operational folders, it is possible to determine the remaining folders in the operational folders as intermediate folders and thus perform an identification processing for identifying to-be-cleaned folders on the determined intermediate folders.

The preset conventional junk judging condition can comprise:

the second-type feature information of a folder conforms to feature information of a preset conventional junk folder;

or,

the first-type feature information of a file in a folder conforms to feature information of a preset conventional junk file;

or,

the second-type feature information of a folder conforms to feature information of a preset conventional junk folder and the first-type feature information of a file in the folder conforms to feature information of a preset conventional junk file.

It should be emphasized that it is possible to statistically analyze which folders among operational folders are conventional junk folders containing conventional junk files, wherein, the conventional junk folders can be directly deleted without requiring users to decide whether to delete them, and then set a conventional junk judging condition based on the determined conventional junk folders. The conventional junk judging condition can be set solely based on feature information of conventional junk folders, or solely based on feature information of conventional junk files in conventional junk folders, or in conjunction with feature information of conventional junk folders and feature information of conventional junk files.

Moreover, the preset conventional junk files and preset conventional junk folders can be determined through the existing technology. For example, it is possible to determine whether a file is a conventional junk file based on the file type, file name and file path and to determine whether a folder is a conventional junk folder based on the folder name or folder path, which will not be repeatedly described here.

S105, determining whether each of the intermediate folders is a to-be-cleaned folder based on the data size of contained files.

After determining intermediate folders in operational folders, it is possible to determine whether each of the intermediate folders is a to-be-cleaned folder based on the data size of contained files since a large folder to be cleaned is determined based on the data size of the folder.

It should be noted that there are many specific implementations for determining whether each of intermediate folders is a to-be-cleaned folder based on the data size of the contained files, and they will be introduced hereinafter in conjunction with specific embodiments and examples for a clear layout.

S106, determining files, other than files in the operational folders, whose data size exceed a first predetermined data size threshold and whose first-type feature information does not conform to preset file feature information as to-be-cleaned files.

Since large files to be cleaned are files of large data size expect those conventional junk files it is possible to set preset file feature information based on feature information of conventional junk files. After determining operational folders, it is possible to determine files, other than files in the operational folders, whose data size exceed a first predetermined data size threshold and whose first-type feature information does not conform to preset file feature information as to-be-cleaned files. The preset file feature information can be set according to feature information of conventional junk files.

The first predetermined data size threshold can be set according to actual situations, and is not limited here.

S107, determining the determined to-be-cleaned files and the determined to-be-cleaned folders as to-be-cleaned data.

After determining the to-be-cleaned files and the to-be-cleaned folders, it is possible to determine the determined to-be-cleaned files and the determined to-be-cleaned folders as to-be-cleaned data, i.e., data that require users to determine whether to delete.

Further, a method for identifying to-be-cleaned data provided by the embodiment of the present application can further comprise:

displaying the determined to-be-cleaned data, wherein, the to-be-cleaned folders are displayed in the form of folder icons and the to-be-cleaned files are displayed in the form of file icons.

In the present embodiment, the following steps are performed: scanning files and folders located in storage space of an electronic device; obtaining data size and first-type feature information of the scanned files and second-type feature information of the scanned folders; determining folders, among the scanned folders, whose second-type feature information conforms to preset folder feature information as operational folders; determining folders, among the determined operational folders, which do not satisfy a preset conventional junk judging condition as intermediate folders; determining whether each of the intermediate folders is a to-be-cleaned folder based on data sized of files contained in this intermediate folder; determining files, other than the files in the operational folders, whose data size exceed a first predetermined data size threshold and whose first-type feature information does not conform to preset file feature information as to-be-cleaned files; determining the determined to-be-cleaned files and the determined to-be-cleaned folders as to-be-cleaned data. As can be seen, large files and large folders to be cleaned in storage space can be identified effectively by applying this solution.

A method for identifying to-be-cleaned data provided by embodiments of the present application will be introduced below in conjunction with a specific embodiment.

It should be noted that, the method for identifying to-be-cleaned data provided by the present embodiment is applicable to an electronic device. In practical applications, the electronic device can be a smart phone, a tablet PC or a laptop and the like.

It should be emphasized that functional software implementing the method for identifying to-be-cleaned data provided by the present embodiment can be specialized client software, and can also be a plug-in of existing cleaning software for cleaning conventional junk data.

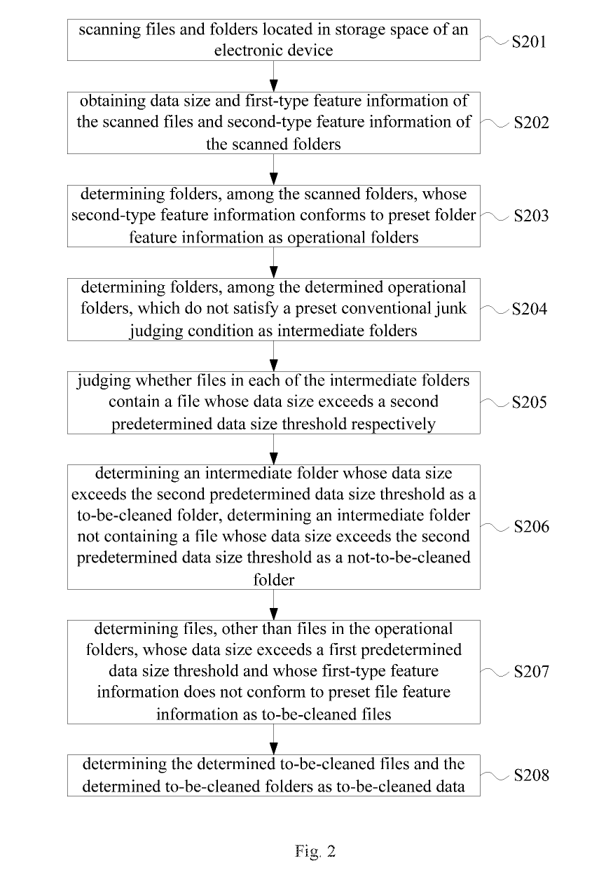

As shown in FIG. 2, the method for identifying to-be-cleaned data provided by the present embodiment can comprise the following steps:

S201, scanning files and folders located in storage space of an electronic device;

S202, obtaining data size and first-type feature information of the scanned files and second-type feature information of the scanned folders;

S203, determining folders, among the scanned folders, whose second-type feature information confirms to preset folder feature information as operational folders;

S204, determining folders, among the determined operational folders, which do not satisfy a preset conventional junk judging condition as intermediate folders.

In the present embodiment, S201 to S204 are similar to S101 to S104 of the above embodiment, which will not be repeatedly described here.

S205, judging whether files in each of the intermediate folders contain a file whose data size exceeds a second predetermined data size threshold;

S206, determining an intermediate folder containing a file whose data size exceeds the second predetermined data size threshold as a to-be-cleaned folder, determining an intermediate folder not containing a file whose data size exceeds the second predetermined data size threshold as a not-to-be-cleaned folder.

After determining the intermediate folders, it is possible to judge whether files in each of the intermediate folders contain a file whose data size exceeds a second predetermined data size threshold respectively, and to perform different operations according to different judgment results. Specifically, it is possible to determine an intermediate folder containing a file whose data size exceeds the second predetermined data size threshold as a to-be-cleaned folder, and to determine an intermediate folder not containing a file whose data size exceeds the second predetermined data size threshold as a not-to-be-cleaned folder.

The second predetermined data size threshold can be set according to actual situations, and is not limited here.

S207, determining files, other than files in the operational folders, whose data sizes exceed a first predetermined data size threshold and whose first-type feature information does not conform to preset file feature information as to-be-cleaned files;

S208, determining the determined to-be-cleaned files and the determined to-be-cleaned folders as to-be-cleaned data.

In the present embodiment, S207 to S208 are similar to S106 to S107 of the above embodiment, which will not be repeatedly described here.

Further, a method for identifying to-be-cleaned data provided by the embodiment of the present application can further comprise:

displaying the determined to-be-cleaned data, wherein, the to-be-cleaned folders are displayed in the form of folder icons and the to-be-cleaned files are displayed in the form of file icons.

As can be seen, large files and large folders to be cleaned in storage space can be identified effectively by applying this solution.

A method for identifying to-be-cleaned data provided by embodiments of the present application will be introduced below in conjunction with another specific embodiment.

It should be noted that, the method for identifying to-be-cleaned data provided by the present embodiment is applicable to an electronic device. In practical applications, the electronic device can be a smart phone, a tablet PC or a laptop and the like.

It should be emphasized that functional software implementing the method for identifying to-be-cleaned data provided by the present embodiment can be specialized client software, and can also be a plug-in of existing cleaning software for cleaning conventional junk data.

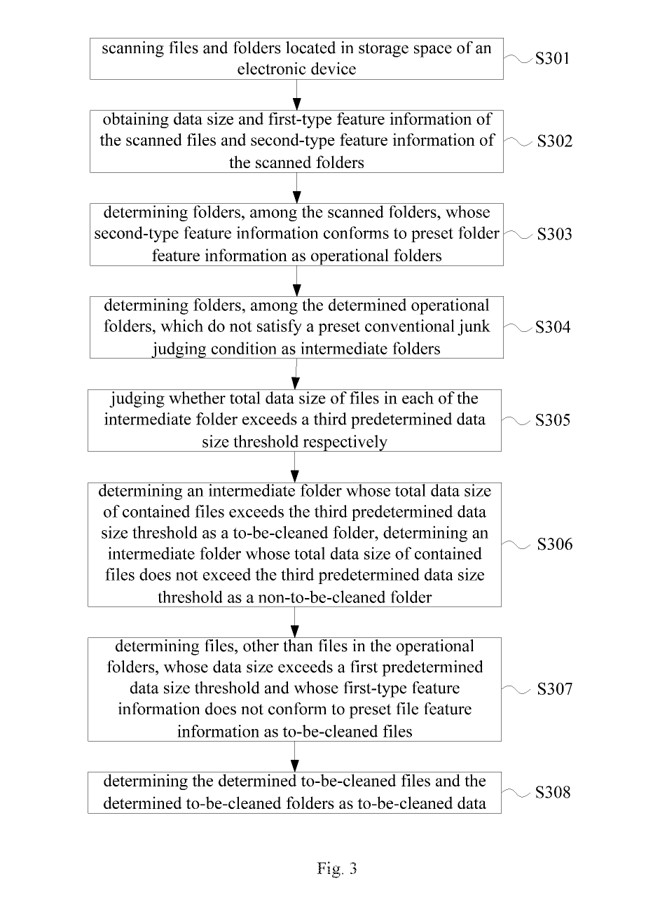

As shown in FIG. 3, the method for identifying to-be-cleaned data provided by the present embodiment can comprise the following steps:

S301, scanning files and folders located in storage space of an electronic device;

S302, obtaining data size and first-type feature information of the scanned files and second-type feature information of the scanned folders;

S303, determining folders, among the scanned folders, whose second-type feature information confirms to preset folder feature information as operational folders.

S304, determining folders, among the determined operational folders, which do not satisfy a preset conventional junk judging condition as intermediate folders.

In the present embodiment, S301 to S304 are similar to S101 to S104 of the above embodiment, which will not be repeatedly described here.

S305, judging whether total data size of files in each of the intermediate folder exceeds a third predetermined data size threshold respectively;

S306, determining an intermediate folder whose total data size of contained files exceeds the third predetermined data size threshold as a to-be-cleaned folder, determining an intermediate folder whose total data size of contained files does not exceed the third predetermined data size threshold as a non-to-be-cleaned folder.

After determining the intermediate folders, it is possible to judge whether total data size of files in each of the intermediate folder exceeds a third predetermined data size threshold respectively, and to perform different operations according to different judgment results. Specifically, it is possible to determine an intermediate folder containing files whose total data size exceeds the third predetermined data size threshold as a to-be-cleaned folder, and to determine an intermediate folder containing files whose total data size does not exceed the third predetermined data size threshold as a non-to-be-cleaned folder.

The third predetermined data size threshold can be set according to actual situations, and is not limited here.

S307, determining files, other than files in the operational folders whose data sizes exceed a first predetermined data size threshold and whose first-type feature information does not conform to preset file feature information as to-be-cleaned files;

S308, determining the determined to-be-cleaned files and the determined to-be-cleaned folders as to-be-cleaned data.

In the present embodiment, S307 to S308 are similar to S106 to S107 of the above embodiment, which will not be repeatedly described here.

Further, a method for identifying to-be-cleaned data provided by embodiments of the present application can further comprise:

displaying the determined to-be-cleaned data, wherein, the to-be-cleaned folders are displayed in the form of folder icons and the to-be-cleaned files are displayed in the form of file icons.

As can be seen, large files and large folders to be cleaned in storage space can be identified effectively by applying this solution.

A method for identifying to-be-cleaned data provided by embodiments of the present application will be introduced below in conjunction with another specific embodiment.

It should be noted that, the method for identifying to-be-cleaned data provided by the present embodiment is applicable to an electronic device. In practical applications, the electronic device can be a smart phone, a tablet PC or a laptop and the like.

It should be emphasized that functional software implementing the method for identifying to-be-cleaned data provided by the present embodiment can be specialized client software, and can also be a plug-in of existing cleaning software for cleaning conventional junk data.

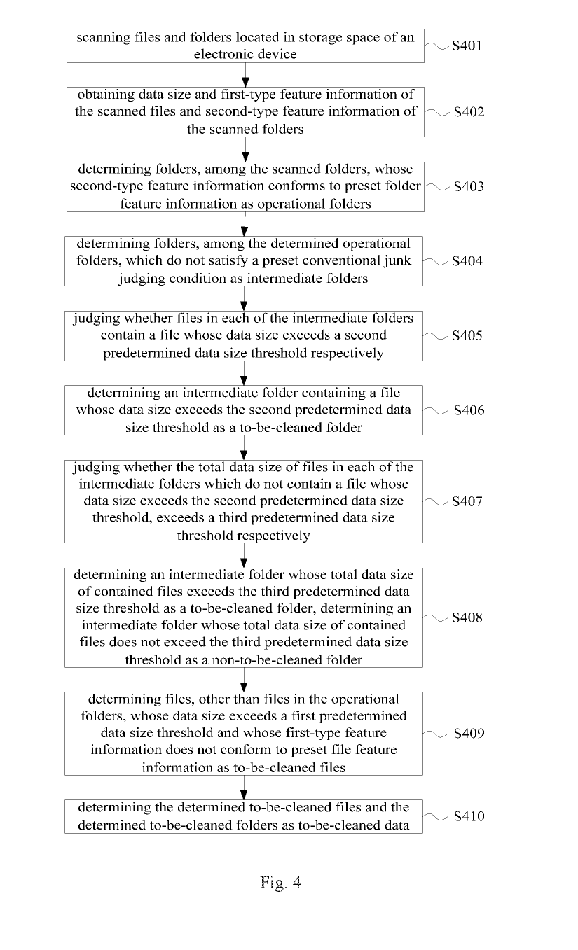

As shown in FIG. 4, the method for identifying to-be-cleaned data provided by the present embodiment can comprise the following steps:

S401, scanning files and folders located in storage space of an electronic device;

S402, obtaining data size and first-type feature information of the scanned files and second-type feature information of the scanned folders;

S403, determining folders, among the scanned folders, whose second-type feature information confirms to preset folder feature information as operational folders;

S404, determining folders, among the determined operational folders, which do not satisfy a preset conventional junk judging condition as intermediate folders.

In the present embodiment, S401 to S404 are similar to S101 to S104 of the above embodiment, which will not be repeatedly described here.

S405, judging whether files in each of the intermediate folders contain a file whose data size exceeds a second predetermined data size threshold;

S406, determining an intermediate folder containing a file whose data size exceeds the second predetermined data size threshold as a to-be-cleaned folder;

S407, judging whether the total data size of files in each of the intermediate folders which do not contain a file whose data size exceeds the second predetermined data size threshold, exceeds a third predetermined data size threshold respectively;

S408, determining an intermediate folder whose total data size of contained files exceeds the third predetermined data size threshold as a to-be-cleaned folder, determining an intermediate folder whose total data size of contained files does not exceed the third predetermined data size threshold as a non-to-be-cleaned folder.

After determining the intermediate folders, it is possible to judge whether files in each of the intermediate folders contain a file whose data size exceeds a second predetermined data size threshold respectively, and to determine an intermediate folder containing a file whose data size exceeds the second predetermined data size threshold as a to-be-cleaned folder; and then to judge whether the total data size of files in each of the intermediate folders which do not contain a file whose data size exceeds the second predetermined data size threshold, exceeds a third predetermined data size threshold respectively, and furthermore to determine an intermediate folder containing files whose total data size exceeds the third predetermined data size threshold as a to-be-cleaned folder, and to determine an intermediate folder containing files whose total data size does not exceed the third predetermined data size threshold as a non-to-be-cleaned folder.

In the present embodiment, the second predetermined data size threshold and the third predetermined data size threshold can be set according to actual situations, and is not limited here.

S409, determining files, other than files in the operational folders, whose data sizes exceed a first predetermined data size threshold and whose first-type feature information does not conform to preset file feature information as to-be-cleaned files;

S410, determining the determined to-be-cleaned files and the determined to-be-cleaned folders as to-be-cleaned data.

In the present embodiment, S409 to S410 are similar to S106 to S107 of the above embodiment, which will not be repeatedly described here.

Further, a method for identifying to-be-cleaned data provided by embodiments of the present application can further comprise:

displaying the determined to-be-cleaned data, wherein, the to-be-cleaned folders are displayed in the form of folder icons and the to-be-cleaned files are displayed in the form of file icons.

As can be seen, large files and large folders to be cleaned in storage space can be identified effectively by applying this solution.

It should be emphasized that the first predetermined data size threshold, second predetermined data size threshold, third predetermined data size threshold are only used to distinguish different predetermined data size thresholds, and have no limitation meaning. Similarly, the above first-type feature information, second-type feature information is only used to distinguish different feature information.

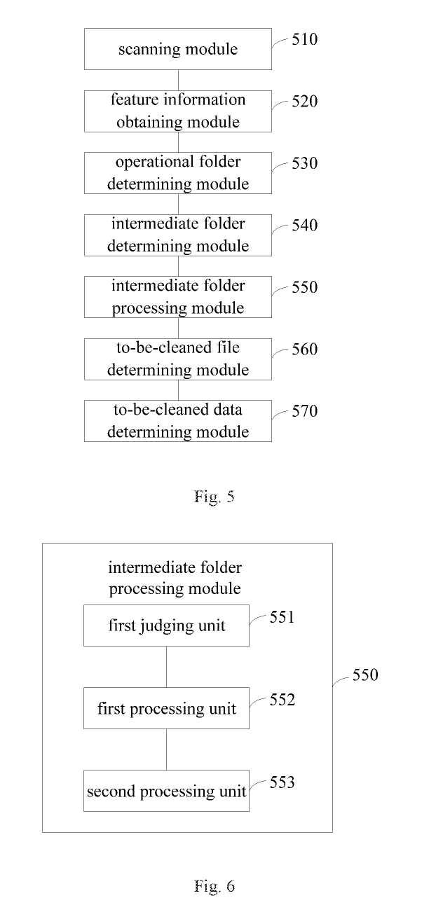

Corresponding to the above method embodiments, embodiments of the present application further provide an apparatus for identifying to-be-cleaned data, which is applicable to an electronic device, as shown in FIG. 5, the apparatus can comprise:

a scanning module 510, used for scanning files and folders located in storage space of an electronic device;

a feature information obtaining module 520, used for obtaining data size and first-type feature information of the scanned files and second-type feature information of the scanned folders;

an operational folder determining module 530, used for determining folders, among the scanned folders, whose second-type feature information confirms to preset folder feature information as operational folders;

an intermediate folder determining module 540, used for determining folders, among the determined operational folders, which do not satisfy a preset conventional junk judging condition as intermediate folders;

an intermediate folder processing module 550, used for determining whether each of the intermediate folders is a to-be-cleaned folder based on data sizes of files contained in this intermediate folder;

a to-be-cleaned file determining module 560, used for determining files, other than files in the operational folders, whose data sizes exceed a first predetermined data size threshold and whose first-type feature information does not conform to preset file feature information as to-be-cleaned files;

a to-be-cleaned data determining module 570, used for determining the determined to-be-cleaned files and the determined to-be-cleaned folders as to-be-cleaned data.

In the embodiment of the present application, the following steps are performed: scanning files and folders located in storage space of an electronic device; obtaining data size and first-type feature information of the scanned files and second-type feature information of the scanned folders; determining folders, among the scanned folders, whose second-type feature information conforms to preset folder feature information as operational folders; determining folders, among the determined operational folders, which do not satisfy a preset conventional junk judging condition as intermediate folders; determining whether each of the intermediate folders is a to-be-cleaned folder based on data sizes of files contained in this intermediate folder; determining files, other than files in the operational folders, whose data size exceed a first predetermined data size threshold and whose first-type feature information does not conform to preset file feature information as to-be-cleaned files; determining the determined to-be-cleaned files and the determined to-be-cleaned folders as to-be-cleaned data. As can be seen, large files and large folders to be cleaned in storage space can be identified effectively by applying this solution.

Specifically, the preset folder feature information can comprise:

feature information of a parent folder of an application program in an operating system, or feature information of a specific folder of the operating system itself.

Specifically, the preset conventional junk judging condition can comprise:

the second-type feature information of a folder conforms to feature information of a preset conventional junk folder;

or,

the first-type feature information of a file in a folder conforms to feature information of a preset conventional junk file;

or,

the second-type feature information of a folder conforms to feature information of a preset conventional junk folder and the first-type feature information of a file in the folder conforms to feature information of a preset conventional junk file.

Specifically, the first-type feature information can comprise at least one of a file type, a file path, and a file name;

the second-type feature information can comprise at least one of a folder name, a folder path, a file type of a file in a folder.

Specifically, in a first implementation, as shown in FIG. 6, the intermediate folder processing module 550 can comprise:

a first judging unit 551, used for judging whether files in each of the intermediate folders contain a file whose data size exceeds a second predetermined data size threshold;

a first processing unit 552, used for determining an intermediate folder containing a file whose data size exceeds the second predetermined data size threshold as a to-be-cleaned folder;

a second processing unit 553, used for determining an intermediate folder not containing a file whose data size exceeds the second predetermined data size threshold as a not-to-be-cleaned folder.

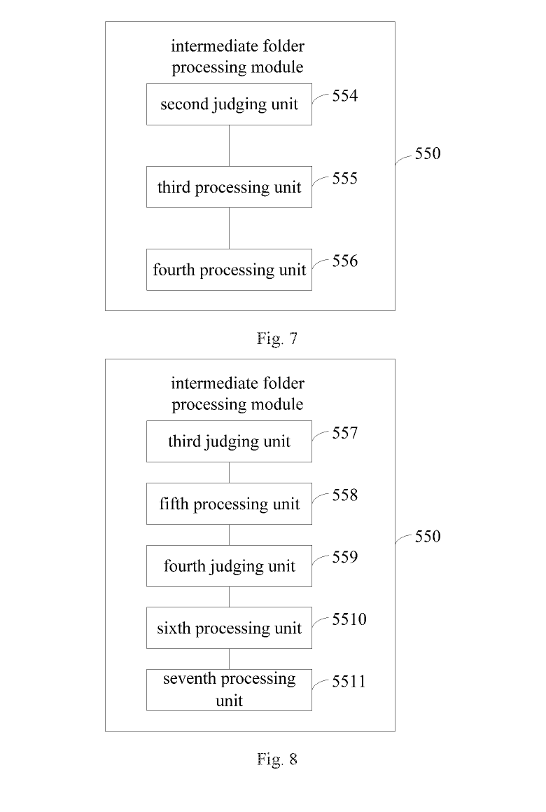

Specifically, in a second implementation, as shown in FIG. 7, the intermediate folder processing module 550 can comprise:

a second judging unit 554, used for judging whether total data size of files in each of the intermediate folder exceeds a third predetermined data size threshold respectively;

a third processing unit 555, used for determining an intermediate folder whose total data size of contained files exceeds the third predetermined data size threshold as a to-be-cleaned folder;

a fourth processing unit 556, used for determining an intermediate folder whose total data size of contained files does not exceed the third predetermined data size threshold as a non-to-be-cleaned folder.

Specifically, in a third implementation, as shown in FIG. 8, the intermediate folder processing module 550 can comprise:

a third judging unit 557, used for judging whether files in each of the intermediate folders contain a file whose data size exceeds a second predetermined data size threshold;

a fifth processing unit 558, used for determining an intermediate folder containing a file whose data size exceeds the second predetermined data size threshold as a to-be-cleaned folder;

a fourth judging unit 559, used for continuing to judge whether the total data size of files in each of the intermediate folders which do not contain a file whose data size exceeds the second predetermined data size threshold, exceeds a third predetermined data size threshold respectively;

a sixth processing unit 5510, used for determining an intermediate folder whose total data size of contained files exceeds the third predetermined data size threshold as a to-be-cleaned folder;

a seventh processing unit 5511, used for determining an intermediate folder whose total data size of contained files does not exceed the third predetermined data size threshold as a non-to-be-cleaned folder.

Further, the apparatus for identifying to-be-cleaned data provided by embodiments of the present application can further comprise:

a displaying module used for displaying the determined to-be-cleaned data, wherein the to-be-cleaned folders are displayed in the form of folder icons and the to-be-cleaned files are displayed in the form of file icons.

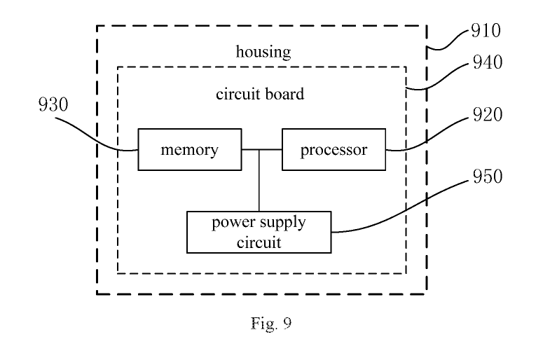

Moreover, an embodiment of the present application further provide an electronic device as shown in FIG. 9, which comprises a housing 910, a processor 920, a memory 930, a circuit board 940 and a power supply circuit 950. The circuit board 940 is placed inside a space enclosed by the housing 910, the processor 920 and the memory 930 are arranged on the circuit board 940. The power supply circuit 950 is used to supply power for various circuits or elements of the electronic device; the memory 930 is used to store executable program code, and the processor 920 runs a program corresponding to the executable program code by reading the executable program code stored in the memory 930 so as to perform the following steps:

scanning files and folders located in storage space of an electronic device;

obtaining data size and first-type feature information of the scanned files and second-type feature information of the scanned folders;

determining folders, among the scanned folders, whose second-type feature information conforms to preset folder feature information as operational folders;

determining folders, among the determined operational folders, which do not satisfy a preset conventional junk judging condition as intermediate folders;

determining whether each of the intermediate folders is a to-be-cleaned folder based on data sizes of files contained in this intermediate folder;

determining files, other than files in the operational folders, whose data sizes exceed a first predetermined data size threshold and whose first-type feature information does not conform to preset file feature information as to-be-cleaned files;

determining the determined to-be-cleaned files and the determined to-be-cleaned folders as to-be-cleaned data.

Regarding to the specific process of the processor 920 performing the above steps and the steps performed by the processor 920 through operating executable program code, reference can be made to the description of the embodiments as shown in FIGS. 1 to 8 of the application, which will not be repeatedly described here.

The electronic device provided by embodiments of the present application performs the following steps: scanning files and folders located in storage space of an electronic device; obtaining data size and first-type feature information of the scanned files and second-type feature information of the scanned folders; determining folders, among the scanned folders, whose second-type feature information conforms to preset folder feature information as operational folders; determining folders, among the determined operational folders, which do not satisfy a preset conventional junk judging condition as intermediate folders; determining whether each of the intermediate folders is a to-be-cleaned folder based on data sizes of files contained in this intermediate folder; determining files, other than the files in the operational folders, whose data sizes exceed a first predetermined data size threshold and whose first-type feature information does not conform to preset file feature information as to-be-cleaned files; determining the determined to-be-cleaned files and the determined to-be-cleaned folders as to-be-cleaned data. As can be seen, large files and large folders to be cleaned in storage space can be identified effectively by applying this solution.

The electronic device is present in a variety of forms, which comprises but is not limited to:

(1) a mobile communication device: this kind of device is characterized in ability of mobile communication and mainly aims to provide voice and data communication. This kind of terminal comprises: smartphones (e.g. iPhone), multimedia phones, functional phones and low-end phones and the like.

(2) an ultra-mobile personal computer device: this kind of device belongs to the category of personal computers, which has functions of computing and possessing and generally possesses mobile networking property. This kind of terminal comprises: PDA, MID and UMPC device and the like, for example an iPad.

(3) a portable entertainment device: this kind of device can display and play multimedia contents. This kind of device comprises: audio and video players (for example, iPods), handheld game consoles, e-books and intelligent toys and portable vehicle navigation devices.

(4) a server: a device providing computing service, the server is consisted of a processor, a hard disk, a memory, system buss and the like. The server is similar to a general computer in architecture, but has a higher requirement in aspects such as processing ability, stability, reliability, security, scalability, manageability due to the need to provide high reliable services.

(5) other electronic devices with data interaction function.

Further, an embodiment of the present application further provide an application program, which is used for performing the method for identifying to-be-cleaned data provided by embodiments of the present application when being executed. The method for identifying to-be-cleaned data comprises:

scanning files and folders located in storage space of an electronic device;

obtaining data size and first-type feature information of the scanned files and second-type feature information of the scanned folders;

determining folders, among the scanned folders, whose second-type feature information conforms to preset folder feature information as operational folders;

determining folders, among the determined operational folders, which do not satisfy a preset conventional junk judging condition as intermediate folders;

determining whether each of the intermediate folders is a to-be-cleaned folder based on data sizes of files contained in this intermediate folder;

determining files, other than files in the operational folders, whose data size exceed a first predetermined data size threshold and whose first-type feature information does not conform to preset file feature information as to-be-cleaned files;

determining the determined to-be-cleaned files and the determined to-be-cleaned folders as to-be-cleaned data.

In embodiments of the present application, the following steps are performed: scanning files and folders located in storage space of an electronic device; obtaining data size and first-type feature information of the scanned files and second-type feature information of the scanned folders; determining folders, among the scanned folders, whose second-type feature information conforms to preset folder feature information as operational folders; determining folders, among the determined operational folders, which do not satisfy a preset conventional junk judging condition as intermediate folders; determining whether each of the intermediate folders is a to-be-cleaned folder based on data sizes of files contained in this intermediate folder; determining files, other than files in the operational folders, whose data size exceed a first predetermined data size threshold and whose first-type feature information does not conform to preset file feature information as to-be-cleaned files; determining the determined to-be-cleaned files and the determined to-be-cleaned folders as to-be-cleaned data. As can be seen, large files and large folders to be cleaned in storage space can be identified effectively by applying this solution.

Furthermore, an embodiment of the present application further provide a storage medium, which is used to store the executable program code that are executed to perform the method for identifying to-be-cleaned data provided by embodiments of the present application. The method for identifying to-be-cleaned data comprises:

scanning files and folders located in storage space of an electronic device;

obtaining data size and first-type feature information of the scanned files and second-type feature information of the scanned folders;

determining folders, among the scanned folders, whose second-type feature information conforms to preset folder feature information as operational folders;

determining folders, among the determined operational folders, which do not satisfy a preset conventional junk judging condition as intermediate folders;

determining whether each of the intermediate folders is a to-be-cleaned folder based on data sizes of files contained in this intermediate folder;

determining files, other than files in the operational folders, whose data size exceeds a first predetermined data size threshold and whose first-type feature information does not conform to preset file feature information as to-be-cleaned files;

determining the determined to-be-cleaned files and the determined to-be-cleaned folders as to-be-cleaned data.

In embodiments of the present application, the following steps are performed: scanning files and folders located in storage space of an electronic device; obtaining data size and first-type feature information of the scanned files and second-type feature information of the scanned folders; determining folders, among the scanned folders, whose second-type feature information conforms to preset folder feature information as operational folders; determining folders, among the determined operational folders, which do not satisfy a preset conventional junk judging condition as intermediate folders; determining whether each of the intermediate folders is a to-be-cleaned folder based on data sizes of files contained in this intermediate folder; determining files, other than files in the operational folders, whose data size exceeds a first predetermined data size threshold and whose first-type feature information does not conform to preset file feature information as to-be-cleaned files; determining the determined to-be-cleaned files and the determined to-be-cleaned folders as to-be-cleaned data. As can be seen, large files and large folders to be cleaned in storage space can be identified effectively by applying this solution.

All embodiments in the description are described in a correlated manner, and identical or similar parts in various embodiments can be referred to one another, the description for each embodiment all focuses on the differences with other embodiments. Especially, the embodiments of a system, an electronic device, an application program and a storage medium are described briefly since they are substantially similar to the method embodiments. Related contents can refer to the description of the method embodiments.

It should be noted that the relationship terms herein such as “first”, “second” and the like are only used to distinguish one entity or operation from another entity or operation, but do not necessarily require or imply that there is actual relationship or order between these entities or operations. Moreover, the terms “include”, “comprise” or any variants thereof are intended to cover a non-exclusive inclusion, such that processes, methods, articles or devices comprising a series of elements comprise not only those elements listed, but also other elements not specifically listed or the elements intrinsic to these processes, methods, articles, or devices. Without further limitations, elements limited by the wording “comprise(s) a/an . . . ” do not exclude that there are additional identical elements in the processes, methods, articles, or devices which comprise the listed elements.

It can be understood by a person skilled in the art that all or a part of steps in the implementations of the above method can be accomplished by instructing related hardware by programs, which can be stored in computer readable storage medium, such as ROM/RAM, disk and optical disk etc.

The embodiments described above are just preferable embodiments of the present application, and are not indented to limit the protection scope of the present application. Any modifications, alternatives, improvements or the like within the spirit and principle of the present application shall be comprised in the protection scope of the present application.

1. A method for identifying to-be-cleaned data, which is applicable to an electronic device, wherein the method comprises:
scanning files and folders located in storage space of the electronic device;
obtaining data size and first-type feature information of the scanned files and second-type feature information of the scanned folders;
determining folders, among the scanned folders, whose second-type feature information conforms to preset folder feature information as operational folders;
determining folders, among the determined operational folders, which do not satisfy a preset conventional junk judging condition as intermediate folders;
determining whether each of the intermediate folders is a to-be-cleaned folder based on data sizes of files contained in this intermediate folder;
determining files, other than files in the operational folders, whose data size exceeds a first predetermined data size threshold and whose first-type feature information does not conform to preset file feature information as to-be-cleaned files;
determining the determined to-be-cleaned files and the determined to-be-cleaned folders as to-be-cleaned data.

2. The method according to claim 1, wherein the preset folder feature information comprises:
feature information of a parent folder of an application program in an operating system, or feature information of a specific folder of the operating system itself.

3. The method according to claim 1, wherein the preset conventional junk judging condition comprises:
the second-type feature information of a folder conforms to feature information of a preset conventional junk folder;
or,
the first-type feature information of a file in a folder conforms to feature information of a preset conventional junk file;
or,
the second-type feature information of a folder conforms to feature information of a preset conventional junk folder and the first-type feature information of a file in the folder conforms to feature information of a preset conventional junk file.

4. The method according to claim 1, wherein the first-type feature information comprises at least one of a file type, a file path, and a file name;
the second-type feature information comprises at least one of a folder name, a folder path, a file type within a folder.

5. The method according to claim 1, wherein determining whether each of the intermediate folders is a to-be-cleaned folder based on data sizes of files contained in this intermediate folder comprises:
judging whether files in each of the intermediate folders contain a file whose data size exceeds a second predetermined data size threshold;
determining an intermediate folder containing a file whose data size exceeds the second predetermined data size threshold as a to-be-cleaned folder;
determining an intermediate folder not containing a file whose data size exceeds the second predetermined data size threshold as a non-to-be-cleaned folder.

6. The method according to claim 1, wherein determining whether each of the intermediate folders is a to-be-cleaned folder based on data sizes of files contained in this intermediate folder comprises:
judging whether the total data size of files in each of the intermediate folders exceeds a third predetermined data size threshold;
determining an intermediate folder whose total data size of contained files exceeds the third predetermined data size threshold as a to-be-cleaned folder;
determining an intermediate folder whose total data size of contained files does not exceed the third predetermined data size threshold as a non-to-be-cleaned folder.

7. The method according to claim 1, wherein determining whether each of the intermediate folders is a to-be-cleaned folder based on data sizes of files contained in this intermediate folder comprises:
judging whether files in each of the intermediate folders contain a file whose data size exceeds a second predetermined data size threshold;
determining an intermediate folder containing a file whose data size exceeds the second predetermined data size threshold as a to-be-cleaned folder;
continuing to judge whether the total data size of files in each of the intermediate folders which do not contain a file whose data size exceeds the second predetermined data size threshold, exceeds a third predetermined data size threshold;
determining an intermediate folder whose total data size of contained files exceeds the third predetermined data size threshold as a to-be-cleaned folder;
determining an intermediate folder whose total data size of contained files does not exceed the third predetermined data size threshold as a non-to-be-cleaned folder.

8. The method according to claim 1, wherein it further comprises:
displaying the determined to-be-cleaned data, wherein the to-be-cleaned folders are displayed in the form of folder icons and the to-be-cleaned files are displayed in the form of file icons.

9. An apparatus for identifying to-be-cleaned data, which is applicable to an electronic device, wherein the apparatus comprises:
a scanning module, used for scanning files and folders located in storage space of the electronic device;
a feature information obtaining module, used for obtaining data size and first-type feature information of the scanned files and second-type feature information of the scanned folders;
an operational folder determining module, used for determining folders, among the scanned folders, whose second-type feature information conforms to preset folder feature information as operational folders;
an intermediate folder determining module, used for determining folders, among the determined operational folders, which do not satisfy a preset conventional junk judging condition as intermediate folders;
an intermediate folder processing module, used for determining whether each of the intermediate folders is a to-be-cleaned folder based on data sizes of files contained in this intermediate folder;
a to-be-cleaned file determining module, used for determining files, other than files in the operational folders, whose data size exceeds a first predetermined data size threshold and whose first-type feature information does not conform to preset file feature information as to-be-cleaned files;
a to-be-cleaned data determining module, used for determining the determined to-be-cleaned files and the determined to-be-cleaned folders as to-be-cleaned data.

10. The apparatus according to claim 9, wherein the preset folder feature information comprises:
feature information of a parent folder of an application program in an operating system, or feature information of a specific folder of the operating system itself.

11. The apparatus according to claim 9, wherein the preset conventional junk judging condition comprises:
the second-type feature information of a folder conforms to feature information of a preset conventional junk folder;
or,
the first-type feature information of a file in a folder conforms to feature information of a preset conventional junk file;
or,
the second-type feature information of a folder conforms to feature information of a preset conventional junk folder and the first-type feature information of a file in the folder conforms to feature information of a preset conventional junk file.

12. The apparatus according to claim 9, wherein the first-type feature information comprises at least one of a file type, a file path, and a file name;
the second-type feature information comprises at least one of a folder name, a folder path, a file type within a folder.

13. The apparatus according to claim 9, wherein the intermediate folder processing module comprises:
a first judging unit, used for judging whether files in each of the intermediate folders contain a file whose data size exceeds a second predetermined data size threshold;
a first processing unit, used for determining an intermediate folder containing a file whose data size exceeds the second predetermined data size threshold as a to-be-cleaned folder;
a second processing unit, used for determining an intermediate folder not containing a file whose data size exceeds the second predetermined data size threshold as a non-to-be-cleaned folder.

14. The apparatus according to claim 9, wherein the intermediate folder processing module comprises:
a second judging unit, used for judging whether the total data size of files in each of the intermediate folders exceeds a third predetermined data size threshold respectively;
a third processing unit, used for determining an intermediate folder whose total data size of contained files exceeds the third predetermined data size threshold as a to-be-cleaned folder;
a fourth processing unit, used for determining an intermediate folder whose total data size of contained files does not exceed the third predetermined data size threshold as a non-to-be-cleaned folder.

15. The apparatus according to claim 9, wherein the intermediate folder processing module comprises:
a third judging unit, used for judging whether files in each of the intermediate folders contain a file whose data size exceeds a second predetermined data size threshold;
a fifth processing unit, used for determining an intermediate folder containing a file whose data size exceeds the second predetermined data size threshold as a to-be-cleaned folder;
a fourth judging unit, used for continuing to judge whether total data size of files in each of the intermediate folders which do not contain a file whose data size exceeds the second predetermined data size threshold, exceeds a third predetermined data size threshold respectively;
a sixth processing unit, used for determining an intermediate folder whose total data size of contained files exceeds the third predetermined data size threshold as a to-be-cleaned folder;
a seventh processing unit, used for determining an intermediate folder whose total data size of contained files does not exceed the third predetermined data size threshold as a non-to-be-cleaned folder.

16. The apparatus according to claim 9, wherein it further comprises:
a displaying module, used for displaying the determined to-be-cleaned data, wherein the to-be-cleaned folders are displayed in the form of folder icons and the to-be-cleaned files are displayed in the form of file icons.

17. An electronic device, comprises a housing, a processor, a memory, a circuit board and a power supply circuit, wherein the circuit board is placed inside a space enclosed by the housing, the processor and the memory are arranged on the circuit board; the power supply circuit is used to supply power for various circuits or elements of the electronic device; the memory is used to store executable program code; and the processor runs a program corresponding to the executable program code by reading the executable program code stored in the memory, so as to perform the following steps:
scanning files and folders located in storage space of the electronic device;
obtaining data size and first-type feature information of the scanned files and second-type feature information of the scanned folders;
determining folders, among the scanned folders, whose second-type feature information conforms to preset folder feature information as operational folders;
determining folders, among the determined operational folders, which do not satisfy a preset conventional junk judging condition as intermediate folders;
determining whether each of the intermediate folders is a to-be-cleaned folder based on data sizes of files contained in this intermediate folder;
determining files, other than files in the operational folders, whose data size exceeds a first predetermined data size threshold and whose first-type feature information does not conform to preset file feature information as to-be-cleaned files;
determining the determined to-be-cleaned files and the determined to-be-cleaned folders as to-be-cleaned data.

18. (canceled)

19. A non-transitory storage medium, which is used for storing executable program code, wherein the executable program code performs the method for identifying to-be-cleaned data according to claim 1 when being executed.
